(19) United States
(12) Patent Application Publication
(10) Pub. No.: US 2006/0024547 A1
(43) Pub. Date: Feb. 2, 2006

(54) ANODE SUPPORTED SOFC WITH AN ELECTRODE MULTIFUNCTIONAL LAYER

(76) Inventors: David Waldbillig, Calgary, Alberta (CA); Anthony Wood, Calgary, Alberta (CA); Tahir Joia, Calgary, Alberta (CA); Eric Tang, Calgary, Alberta (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 11/161,196

(22) Filed: Jul. 26, 2005

Related U.S. Application Data
(60) Provisional application No. 60/521,961, filed on Jul. 27, 2004.

(51) Int. Cl. H01M 8/10; B05D 5/12; H01M 4/86

(52) U.S. Cl. 429/33; 429/40; 427/115

(57) ABSTRACT

The invention is directed to a fuel cell which is configured to avoid deformation caused by differential shrinking, and which mitigates the damage caused by the introduction of an oxidizing environment in the anode cavity during the operation of the fuel cell. The fuel cell has a cathode, an electrolyte, an anode and a porous multifunctional layer disposed on the anode opposite to the electrolyte. The porous multifunctional layer comprises a cermet which has thermal expansion and shrinkage behaviour substantially similar to the other fuel cell layers.

### CROSS REFERENCE TO RELATED APPLICATIONS

This application claims the priority benefit of U.S. Provisional Application No. 60/521,961 filed on Jul. 27, 2004 entitled “Anode Supported SOFC With An Electrode Multifunctional Layer”, the contents of which are incorporated herein by reference.

### FIELD OF THE INVENTION

The present invention relates to an anode-supported solid oxide fuel cell having an electrode multifunctional layer.

### BACKGROUND OF THE INVENTION

Solid oxide fuel cells (SOFCs) are an energy generation technology that produces electricity quietly, cleanly and efficiently through the direct electrochemical combination of a fuel with an oxidant. This direct production of electricity effectively bypasses the conversion of the fuel's chemical energy into thermal and mechanical energy and thus allows higher theoretical efficiencies to be achieved. The reactants (fuel and oxidant) are supplied to the cell through manifolds and flow fields that direct the reactants to the appropriate sides of a solid ceramic membrane that acts as an electrolyte. The membrane is coated with electrodes on both sides and permits transfer of ions of the oxidant, but does not permit transfer of electrons. Thus the streams of reactants are kept separate, but the electrons and ions from the reactants are allowed to react. Electrons are emitted at the fuel side electrode of the solid electrolyte membrane and absorbed at the oxygen side electrode thereby generating a potential difference between the two electrodes. The solid electrolyte membrane separates the reactants; transfers the charge in the form of ions and, at the same time, prevents an electron short circuit between the two electrodes of the solid electrolyte. For this purpose, the solid electrolyte membrane has a low electronic conductivity but at the same time, a high ionic conductivity.

A typical planar SOFC may be anode supported where the electrolyte and cathode are thin layers applied to a structural anode substrate. Because SOFCs are made of a number of distinct layers (anode substrate, anode functional layer, electrolyte, cathode functional layer) made of differing materials that are cofired together, each of these layers will shrink differently during cofiring. This differential shrinkage causes the cell to deflect or deform after cofiring. The deformation typically results in a domed shaped cell. One approach is to reduce cell curvature through high temperature ironing. However, ironing is a separate high temperature firing step that uses up resources and takes time. As well each high temperature firing step coarsens the fuel cell microstructure slightly, which may degrade its performance.

In anode supported planar solid oxide fuel cell (SOFC) construction, a typical anode is commonly made from a cermet mixture of nickel and yttria stabilized zirconia (YSZ). In a reducing atmosphere at the anode, nickel oxide will not form provided that the fuel supply is maintained and the voltage stays above the thermodynamic equilibrium potential of nickel and nickel oxide. If the fuel supply is cut off, such as may occur during emergency shutdown of an SOFC system, air can leak into the anode cavity, which causes rapid oxidation of the anode. This is undesirable since there is a volume expansion when nickel oxidizes that can potentially damage the structure of the cell by causing layer delamination or electrolyte cracking. If the electrolyte cracks, the fuel and oxidant gases will be able to mix directly, with potentially catastrophic results.

In International Patent Application WO 01/43524, an anode stress compensation layer is provided which is essentially a dense layer of zirconia. In order to allow fuel to pass through and contact the anode, large openings in the stress compensation layer are provided. Because of the size of the openings, there may be difficulties with non-uniform gas distribution and anode contact.

International Patent Application WO 2004/006365 attempts to address the shortcomings in this approach by providing a stress compensation layer of zirconium oxide, which is described as continuous but which defines a plurality of small openings in a regular pattern, such as a hexagonal pattern, in order to allow the passage of the fuel gas. An electron-conducting layer such as a porous nickel/nickel oxide is then applied over the stress compensation layer. This latter solution requires four distinct anode layers: an anode functional layer, an anode support, the stress compensation layer and an electron-conducting layer. As a result, this fuel cell is more complex than desired and requires many more steps to construct than is optimum. As well, the small openings in the YSZ stress compensation layer may excessively limit the amount of fuel that can flow through this layer, which may cause mass transport losses to occur at higher current density of the operating conditions.

Therefore, there is a need in the art for a fuel cell which is configured to avoid deformation caused by differential shrinkage and which mitigates the difficulties of the prior art. Furthermore, there is a need in the art to mitigate the damage caused by the introduction of an oxidizing environment in the anode cavity during operation of the fuel cell.

### SUMMARY OF THE INVENTION

The invention may comprise a solid oxide fuel cell comprising a cathode, an electrolyte, an anode substrate and an anode functional layer disposed between the anode substrate and electrolyte, and further comprising a porous multifunctional layer disposed on the anode substrate, opposite to the electrolyte, said multifunctional layer comprising a cermet which is at most about 50% porous in a reduced state and less than about 30% in an oxidized state. The multifunctional layer cermet preferably comprises metal and ceramic particles, such as nickel and zirconia with a finer microstructure than the anode substrate. In one embodiment, the multifunctional layer is less than 50% porous in a reduced state and less than about 15% porous when in an oxidized state.

The multifunctional layer preferably has thermal expansion and shrinkage behaviour substantially similar to the other fuel cell layers, and the anode functional layer in particular.

In another aspect, the invention may comprise a solid oxide fuel cell comprising a cathode, an electrolyte, an anode substrate and an anode functional layer disposed between the anode substrate and electrolyte, and further comprising a porous multifunctional layer disposed on the anode substrate, opposite the anode functional layer, said multifunctional layer comprising metal and ceramic particles less than 5 microns in size, wherein said functional layer is porous when in a reduced state to allow fuel cell operation, and which becomes substantially less porous when in an oxidized state to prevent oxidation damage to the anode substrate and/or anode functional layer In another aspect, the invention may comprise a method of producing a solid oxide fuel cell, comprising the sequential or non-sequential steps of:

(a) producing an anode substrate layer having a first major surface and a second major surface;

(b) applying an electrolyte layer on the first major surface of the anode layer;

(c) applying a cathode layer on the electrolyte layer, opposite the anode layer; and

(d) applying a multifunctional layer to the anode substrate on the second major surface, wherein the multifunctional layer is a substantially continuous porous electron-conducting cermet having thermal expansion and shrinkage behaviour substantially similar to the other fuel cell layers;

(e) cofiring of the deposited layers.

Preferably, the method further comprises the step of depositing an anode functional layer disposed between the anode substrate layer and the electrolyte. The multifunctional layer cermet preferably comprises nickel and zirconia particles with finer microstructure than the substrate and is less than about 50% porous in a reduced state and less than about 15% porous when in an oxidized state.

### BRIEF DESCRIPTION OF THE DRAWINGS

The invention will now be described by way of an exemplary embodiment with reference to the accompanying simplified, diagrammatic, not-to-scale drawings. In the drawings:

FIG. 1 is a schematic representation of one embodiment of a fuel cell of the present invention;

FIG. 2 is a scanning electron micrograph of a functional layer of one embodiment;

FIG. 3 is a schematic diagram showing the location of flex measurements on the cell.

### DETAILED DESCRIPTION OF THE INVENTION

The present invention provides for a solid oxide fuel cell configured to minimize deformation caused by differential shrinkage during co-firing and to provide an oxidation barrier. When describing the present invention, all terms not defined herein have their common art-recognized meanings.

The term “cermet” refers to a mixture of a ceramic material and a metallic material, wherein the two materials are not chemically bonded together. As used herein, the term “about” refers to a range of values that is the stated value plus or minus 10%. The term “redox” refers to cyclic reduction and oxidation.

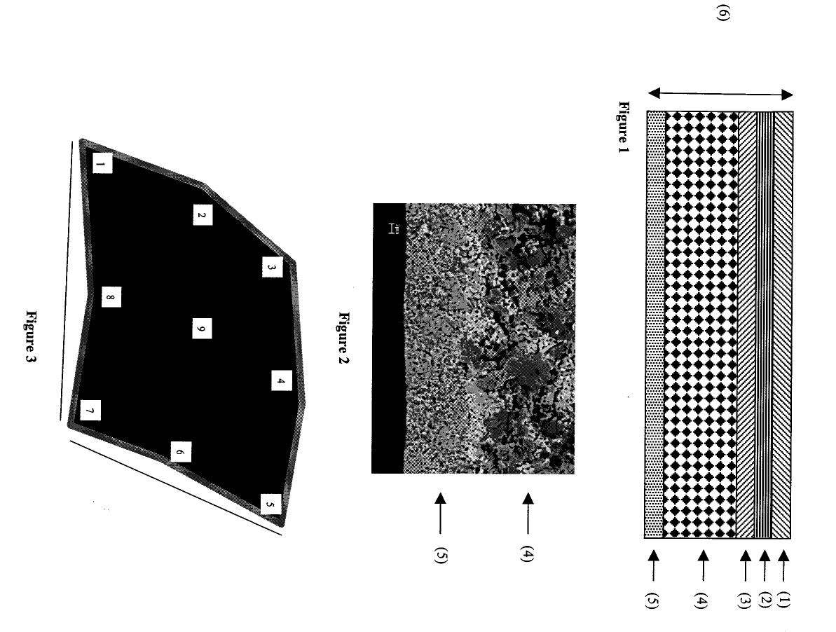

In one embodiment, as shown in FIG. 1, the invention comprises an anode-supported solid oxide fuel cell (6) where the anode substrate (4) is comprised of a porous relatively coarse microstructured yttria stabilized zirconia (YSZ) and nickel cermet, the anode functional layer (3) is comprised of a porous fine microstructured YSZ and nickel cermet, and the electrolyte (2) is comprised of solid YSZ. A cathode functional layer (1) is provided on the opposite of the electrolyte (2). A multifunctional layer (5) is added to the underside of the anode substrate as shown in FIGS. 1 and 2.

As is conventionally known, the dense solid electrolyte (2) has only a limited amount of porosity, preferably no more than about five percent porosity (by volume), so that gas cannot flow through the solid electrolyte. The electrolyte is commonly made from YSZ. In alternative embodiments, the electrolyte may be made from materials other than YSZ, such as scandia stabilized zirconia (ScSZ), or cerium oxide doped with materials such as Gd and Sm. In another alternative embodiment, the electrolyte may be made from strontium and magnesium doped lanthanum gallate (LSGM-La₁₋ₓSrₓGa_{1-y}Mg_{y}O_{3-δ}) or any other ionically conducting material.

The ceramic component in the cermet anode may be any known ceramic such as YSZ. In a preferred embodiment, the ceramic phase is preferably the same material as the electrolyte so that interface between the ceramic phase and the electrolyte is chemically stable and there is a good thermal expansion match between the two materials.

The metal component may be any metal, and may preferably be a transition metal such as nickel, iron, copper or cobalt. Nickel is commonly used because it is relatively less expensive, it is a good electrical conductor, and it is a strong catalyst for fuel oxidation and reforming. In one embodiment, the anode substrate (4) cermet is typically about 40% porous when reduced and is comprised of relatively large nickel particles with smaller zirconia particles. A preferred anode substrate has two types of porosity: small pores within the YSZ matrix and larger (1 to 5 micron) pores surrounding the Ni particles.

The anode functional layer (3) may also comprise a cermet of nickel and YSZ, which is preferably prepared from fine powders (less than 5 microns in size). The microstructure of the anode functional layer is preferably less than about 50% porous when reduced. The weight ratio of nickel to YSZ in the layer may be about equal. The anode functional layer (3) may be screen printed onto the anode substrate using techniques well-known to those skilled in the art or may be deposited using any other well known deposition technique such as tape casting, chemical vapour deposition (CVD), physical vapour deposition (PVD), plasma spraying, dip coating and the like.

In one embodiment, the anode functional layer (3) is about 15 microns thick, however the anode functional layer (3) may be 5 to 25 microns thick if desired. The anode substrate may be about 1 mm thick or may be between 250 microns and 1.5 mm thick.

The electrolyte (2) is fabricated from an ionically conductive ceramic material such as YSZ. This layer is deposited on top of the anode functional layer using any of the well known deposition techniques mentioned previously. The electrolyte is desired to be as thin as possible in order to minimize resistive losses, but its thickness is usually on the order of 10 microns in order to ensure that it has no connected porosity which would allow fuel and oxidant gases to mix.

A cathode functional layer (1) is deposited on top of the electrolyte layer. This layer has a fine microstructure in order to enhance the electrochemical reactions that occur and can be deposited using any of the deposition methods mentioned previously.

In one embodiment of this invention, a fifth multifunctional layer (5) is deposited onto the anode substrate (4) on the side opposite to the electrolyte as shown in FIG. 1. This multifunctional layer (5) may be comprised of a cermet comprising of a mixture of metal and ceramic particles with finer microstructure than the anode substrate (4) and is porous, preferably with evenly dispersed pores. The metallic particles may preferably consist of Ni or any other metal which may be oxidized and reduced under typical SOFC operating conditions. The ceramic particles may consist of an ionically conductive material such as YSZ or may be fabricated from other ceramic materials such as alumina. The composition and microstructure of the multifunctional layer (5) may be similar to that of a conventional anode layer in a typical SOFC, or it may be composed of the same materials in a different ratio of compositions, or it may be composed of a completely different set of materials. The porosity in this layer is preferably less than about 50% when the layers is reduced and preferably less than 15% (more preferably less than 5%) when the layer is fully oxidized.

This multifunctional layer (5) may be deposited using any well known deposition techniques, including those described herein, such as screen printing. The multifunctional layer is preferably about 15 microns in thickness in order to limit gas diffusion difficulties, but it may be as thick as 50 to 100 microns thick in order to optimize its functionality. The multifunctional layer may be deposited with the metal part of the cermet in the form of an oxide (e.g. nickel oxide) which will later be converted to a metal upon reduction (e.g. nickel oxide could be reduced to nickel metal). This is to allow firing of the cell at high temperature in air environment.

The fine microstructure of the multifunctional layer (5) achieved by printing the cermet particles may experience shrinkage during firing of the cell substantially equivalent to that of the other cell layers. As a result, the cell may remain relatively flat, within stack assembly tolerances, without the need for a separate ironing or flattening step.

As the multifunctional layer (5) is significantly less porous than the anode substrate (4) and has a much finer microstructure, it will densify rapidly upon oxidation, because as the metallic component oxidizes, it will expand and fill the pore volume. As a result, the multifunctional layer will act as a gas barrier in oxidizing conditions. As may be appreciated, there will be a minimum porosity required in order to ensure that mass transport losses induced as a result of fuel flow constriction during operation are minimized. However, the less porous the multifunctional layer or the higher the content of metal component present, the better the multifunctional layer will act as an oxidation barrier and as a structural stabilizing layer during cofiring of the cell. It is believed that a porosity of less than about 50% for the multifunctional layer in a reduced state is a suitable compromise. When oxidized, the multifunctional layer's porosity may be reduced to about 15% or less.

It will also be apparent to those skilled in the art having regard to this disclosure that other modifications of this invention beyond those embodiments specifically described here may be made without departing from the spirit of the invention. Accordingly, such modifications are considered within the scope of the invention as limited solely by the appended claims.

### EXAMPLE

This example discloses a method of making an anode-supported fuel cell with a multifunctional layer as described above and illustrates the ability of the multifunctional layer to enhance both cell flatness after cofiring and redox tolerance.

A SOFC as described above has been produced using tape casting and screen printing methods. The anode substrate is produced by a single layer tape cast of a 57 wt % NiO/43 wt % YSZ slurry to produce green tape approximately 1 mm in thickness where NiO particles are several microns in size and the YSZ particles are less than 5 microns in size. The other fuel cell layers are deposited on this green (unfired) tape via screen printing. The anode functional layer, electrolyte and cathode functional layers are deposited sequentially on one side of the anode substrate while the electrode multifunctional layer is deposited on the other side of the anode substrate. The anode functional layer is a fine structured 57 wt % NiO/43 wt % YSZ mixture, the electrolyte is comprised of YSZ and the cathode functional layer may be any commonly used SOFC cathode material, such as strontium doped lanthanum manganite (LSM). The electrode multifunctional layer consists of a mixture of fine NiO and YSZ particles that are less than 5 microns in size. A minimum Ni content of 30 volume % is preferred in this cermet layer in order to ensure that the network of Ni particles has sufficient connections in order for the sample to have sufficient electronic conductivity. After all of the layers are deposited, the sample is cofired in air at a temperature greater than 1300° C. After cofiring the cell is about 1.1 mm thick with an anode substrate layer about 1 mm thick, an anode functional layer about 15 microns thick, an electrolyte about 10 microns thick and a multifunctional layer about 15 microns thick.

After cofiring, the amount of curvature (flex) was measured for standard cells (no multifunctional layer) before and after ironing and compared with the flex of cells that had a multifunctional layer printed on the cell bottom. It can be seen in Table 1 that the average flex measurements of the cells with multifunctional layers were much lower than standard cells before ironing and were equivalent to ironed standard cells. This difference was especially apparent for corner flex measurements (measurements 1, 3, 5, 7 shown schematically in FIG. 3).

TABLE 1
Summary of flex measurements.

| | Corner | Edge | Center |
|---|---|---|---|
| Standard cell | 2.0 | 0.4 | 1.0 |
| (before ironing) | | | |
| Standard cell | 0.1 | 0.2 | 0.5 |
| (after ironing) | | | |
| Cell with multi- | 0.2 | 0.2 | 0.7 |
| functional layer | | | |

Note:
Corner measurements include measurements 1, 3, 5 and 7 in FIG. 3
Edge measurements include measurements 2, 4, 6 and 8 in FIG. 3
The center measurement is measurement 9 in FIG. 3
All flex measurements are in mm.

The corner measurements include measurements 1, 3, 5 and 7 in FIG. 3. The edge measurements include measurements 2, 4, 6 and 8 in FIG. 3. The center measurement is measurement 9 in FIG. 3. All flex measurements are in mm.

The redox tolerance of cells with a multifunctional layer was compared to standard cells using single cell electrochemical testing methods. The cell's initial performance was characterized and then air was blown over the anode in order to reoxidize the cell. The cell was then reduced and the electrochemical performance was measured again.

Table 2 summarizes the single cell testing results for the standard cell redox test and for cells with a multifunctional layer. It can be seen from the figure that the cells with a multifunctional layer had significantly enhanced the redox tolerance for redox cycles up to four hours in length. All tests were performed at 750° C. and 60 A.

TABLE 2
Summary of the cumulative percent
degradation after redox cycling

Cumulative percent degradation

| Redox | Standard | Cell with multi- |
|---|---|---|
| time (min) | cell | functional layer |
| 20 | −0.84% | −0.97% |
| 40 | −1.20% | −1.09% |
| 60 | −1.91% | −1.21% |
| 120 | −4.07% | −2.90% |
| 240 | −8.13% | −4.83% |
| 360 | −10.77% | −9.77% |

What is claimed is:

1. A solid oxide fuel cell comprising a cathode, an electrolyte, an anode substrate and an anode functional layer disposed between the anode substrate and electrolyte, and further comprising a porous multifunctional layer disposed on the anode substrate, opposite to the electrolyte, said multifunctional layer comprising a cermet which is at most about 50% porous in a reduced state and less than about 30% in an oxidized state.

2. The fuel cell of claim 1 wherein the cermet comprises metal and ceramic particles with finer microstructure than the anode substrate.

3. The fuel cell of claim 1 wherein the cermet multifunctional layer is between about 20% porous and about 50% porous in a reduced state and less than about 30% porous when in an oxidized state.

4. The fuel cell of claim 2 wherein the metal comprises nickel.

5. The fuel cell of claim 2 wherein the ceramic comprises zirconia.

6. The fuel cell of claim 2 wherein the multifunctional layer has thermal expansion and shrinkage behaviour substantially similar to the anode functional layer.

7. A solid oxide fuel cell comprising a cathode, an electrolyte, an anode substrate and an anode functional layer disposed between the anode substrate and electrolyte, and further comprising a porous multifunctional layer disposed on the anode substrate, opposite the anode functional layer, said multifunctional layer comprising metal and ceramic particles less than 5 microns in size, wherein said functional layer is porous when in a reduced state to allow fuel cell operation, and which becomes substantially less porous when in an oxidized state to prevent oxidation damage to the anode substrate and/or anode functional layer.

8. The fuel cell of claim 7 wherein the metal comprises nickel and the ceramic comprises zirconia.

9. A method of producing a solid oxide fuel cell, comprising the sequential or non-sequential steps of:
(a) producing an anode substrate layer having a first major surface and a second major surface;
(b) applying an electrolyte layer on the first major surface of the anode layer;
(c) applying a cathode layer on the electrolyte layer, opposite the anode layer; and
(d) applying a multifunctional layer to the anode substrate on the second major surface, wherein the multifunctional layer is a substantially continuous porous electron-conducting cermet having thermal expansion and shrinkage behaviour substantially similar to the other fuel cell layers;
(e) cofiring of the deposited layers.

10. The method of claim 9 further comprising the step of depositing an anode functional layer disposed between the anode substrate layer and the electrolyte.

11. The method of claim 9 wherein the cermet comprises nickel and zirconia particles less than 5 microns in size and is less than about 50% porous.

12. The method of claim 11 wherein the cermet is less than about 30% porous when in a reduced state and less than about 5% porous when in an oxidized state.
